(19) United States
(12) Patent Application Publication
(10) Pub. No.: US 2007/0043761 A1
(43) Pub. Date: Feb. 22, 2007

(54) SEMANTIC DISCOVERY ENGINE

(75) Inventors: Nicholas Chim, Menlo Park, CA (US); Edward M. Shelton, Berkeley, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: The Personal Bee, Inc., Berkeley, CA (US)

(21) Appl. No.: 11/466,280

(22) Filed: Aug. 22, 2006

Related U.S. Application Data
(60) Provisional application No. 60/710,251, filed on Aug. 22, 2005.

(51) Int. Cl. G06F 7/00

(52) U.S. Cl. 707/102

(57) ABSTRACT

Discovering topics of interest from the content received from multiple sources. Content from multiple sources is aggregated and stored in a database along with the content's metadata. Phrases are extracted from the content and scored based on at least a time window for each phrase. The high ranking phrases are presented to a user via a user interface. When a user selects a particular phrase, content corresponding to the selected phrase is presented to the user. The content may include a list of ranked documents or a specific document. The phrases presented to the user can also be topic specific.

### CROSS REFERENCE TO RELATED APPLICATIONS

This application claims the benefit of U.S. Provisional Application Ser. No. 60/710,251, filed Aug. 22, 2005 and entitled SEMANTIC DISCOVERY ENGINE, which application is incorporated by reference in its entirety.

### BACKGROUND OF THE INVENTION

1. Field of the Invention

The present invention relates to the field of semantic discovery. More particularly, embodiments of the invention relate to systems and methods for discovering content of interest including topical content.

2. Background and Related Art

Information and the ability to access information are important parts of everyday life. In an information-rich world, people are faced with a multitude of information sources from which to consume information of interest. Printed publications and online publications are examples of the content that is currently available today. With regard to online publications, the advent of search engines has allowed us to quickly search billions of documents very quickly. However, the search process requires us to define our topic of interest as the first step in the search query process.

In contrast, people generally do not have any notion of the stories that are on the front page of the morning paper. People entrust newspaper editors to decide which articles appear on the front page as well as in the newspaper. Generally, stories covered in newspapers constitute topics of primary community interest. However, each person also has his or her own personal interest topics that lie outside of these community interests. In addition, some people may want to have more articles or content than is currently available a typical newspaper edition.

Traditionally to address this need for more information or for different perspectives on a given topic, people often read multiple newspapers, magazines, or websites, and they conveniently skip redundant articles that appear in multiple sources. For readers who can devote 1-2 hours per day to this activity, this traditional method may be a suitable solution. However, as readers begin to include more sources, say 10-100 sources, their reading time compresses to tens of minutes, and readers are faced with an intractable problem.

This problem is further complicated by the fact that the content available in printed publications is static and unchanging while the content available to people in online publications or websites is typically dependent on a user's ability to formulate an appropriate search request. In addition, an online search typically has thousands of results and people are generally unable to peruse each of these search results and, in any event, many of the search results are not particularly relevant from the user's perspective. There is therefore a need for systems and methods that can identify content of interest.

### BRIEF SUMMARY OF THE INVENTION

These and other limitations are overcome by embodiments of the invention, which relates to systems and methods for providing content to users or for discovering topics of content. Generally, topics of content are discovered for a user by generating or extracting phrases from the content and then scoring phrases in various manners as disclosed herein. Embodiments of the invention enable a user to digest large amounts of content by presenting a phrase cloud to a user that includes scored or ranked phrases. The selection of a particular phrase returns, in one embodiment, a list of ranked documents that are associated with the selected phrase.

One embodiment of the invention is a method for discovering topics of content from multiple sources of content. The method may be an ongoing process that is continually repeated as new content becomes available and/or as the content ages. The method typically begins by aggregating content from the various sources. The metadata from the content or associated with the content may also aggregated and stored in a database with the content. Next, phrases are extracted from the stored content. The phrases are then scored using various factors. By way of example, a time window of interest, a historical frequency, the newness of the content, and the like are examples of factors that are used to determine a phrase score for each phrase.

After the phrase scores are computed for the extracted phrases, a phrase cloud may be generated and presented to a user. The phrase cloud typically includes those phrases that have the best ranking and that are relevant, in one embodiment, to a particular topic. Advantageously, the phrase cloud can be updated or refreshed over time. The phrase cloud also has the advantage of being dynamic, and of being time relevant. As mentioned above, the phrases have a time component in some instances that may be used in the determination of the phrase score. Additionally, the phrases can be extracted from actual content. Extracting content can also include inferring content. In other words, some of the phrases may not actually be in the content, but is inferred from the content.

The phrase cloud (or other suitable representation of certain phrase) is then presented to a user. Often, the phrase cloud includes visual clues, such as different colors for different phrases, that enable, for example, a user to quickly and easily distinguish one phrase for another. Font size is another example of a visual cue that enables a user to determine the relative rank of a phrase. Some embodiments of the invention also remove duplicate phrases. This ensures that the phrase cloud is not redundant, but has phrases that are associated with distinct content. The selection of a phrase by a user results in the presentation of content or of a list of ranked documents to the user. When the user selects a particular document, the document is presented to the user or the user is linked to the source of the particular document.

Additional features and advantages of the embodiments disclosed herein will be set forth in the description which follows, and in part will be obvious from the description, or may be learned by the practice of the invention. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates an exemplary environment for implementing embodiments of the invention and also illustrates a phrase cloud delivered to clients;

FIG. 2 illustrates an exemplary system for discovering content from multiple sources;

FIG. 3 illustrates one embodiment of a user interface that includes a phrase cloud that includes certain phrases that are determined by a semantic engine;

FIG. 4 is an exemplary flow diagram of a method for discovering content; and

FIG. 5 illustrates a table view of phrases that are stored in a database and processed by a semantic engine to identify phrases and determine phrase scores that may be used to generate a phrase cloud or other representation of content.

### DESCRIPTION OF THE INVENTION

The present invention relates to a semantic discovery engine that takes a collection of information sources and “discovers” the key topics of interest or content available from the information sources. This system performs, among others, two exemplary functions, among others, that solve the problems that have been experienced by readers who have tried to digest large volumes of material. In particular, the semantic discover engine: 1) ranks topics by popularity or by other factor(s) so reading can be prioritized; and 2) groups similar documents together under a single topic so that readers do not need to sort through redundant information.

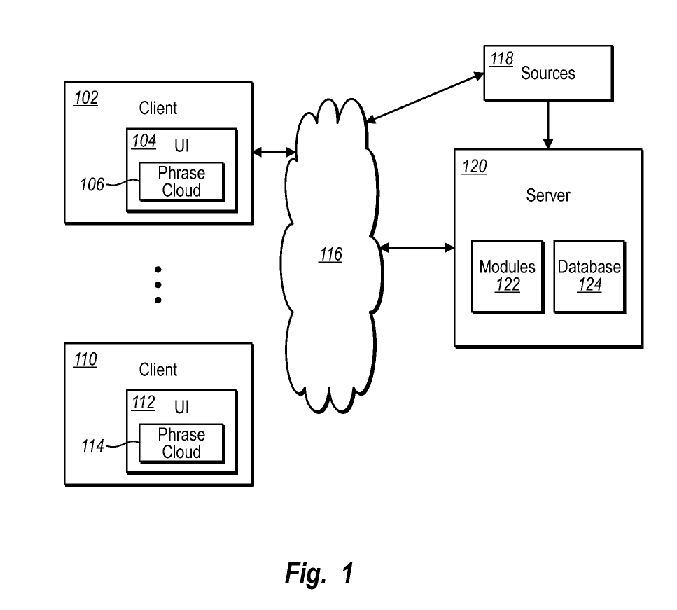

FIG. 1 illustrates an exemplary environment for implementing embodiments of the invention. The system 100 illustrates multiple computers (including client computers and server computers) that are joined via a network 116. In this example, the network 116 is the Internet, but the network 116 may also be a wide area network, a local area network, an 802.xx network, and the like or any combination thereof The clients illustrated in FIG. 1 are also representative of other user devices such as personal digital assistants, cellular telephones, and the like or any combination thereof

In FIG. 1, the sources 118 represent sources of content (also referred to herein as data, documents, publications, etc.) that may be of interest to various users. Exemplary sources 118 include, but are not limited to RSS feeds, websites, text, news, blogs, websites, and the like or any combination thereof Some of the sources 118 actively broadcast data while others can be accessed, refreshed, searched, updated, and the like.

As indicated previously, a user may desire to view the content provided by the sources 118. However, the number of the sources 118 and the amount of content stored by or available from the various sources 118 makes this impractical as discussed previously. Embodiments of the invention enable a user to digest large volumes of content stored or presented by the sources 118. In some instances, access to the content of the sources 118 can be customized by the end user. For example, a user may prioritize topics or group similar documents by topic.

Client computers or other client devices, represented by the client 102 and the client 110, are able to interact with a server 120 over the network 116. The clients 102 and 110 may also have access to the sources 118 over the network 116. As discussed previously, however, the ability of the clients 102 and 110 to effectively access the content of the sources 118 directly often depends on the ability of end users to formulate appropriate search requests, access specific sites, and the like.

In accordance with embodiments of the invention, the clients 102 and 110 can access the server 120 to receive data that is representative of content or that links to specific instances of content from the sources 118. In some instances, the server 120 stores copies of content from the sources 118 and can present these copies to the clients 102 and 110. The server 120 can receive content directly from the sources 118 and/or over the network 116.

The server 120 receives content from the sources 118 and stores the content using a database 124. The database 124 may be a relational database. Various modules 122 operate on the content received from the sources 11 8 to extract phrases that are indicative of the content received from the sources 118. Some of the phrases are then presented as a phrase cloud to a user based on phrase scores, for example, that are generated by the modules 122. The phrase cloud typically includes links that, when selected by a user, present specific content or a specific group of content to the user. The phrase cloud, such as the phrase clouds 106 and 114 in the user interfaces 104 and 112, respectively, present a digest of the content generated by the sources 118. The phrase clouds 106 and 114, however, may be based on extracted content, include actual or inferred content from the sources, be dynamically generated, and/or be time relevant.

### I. Overview of Embodiments of Semantic Discovery Engine

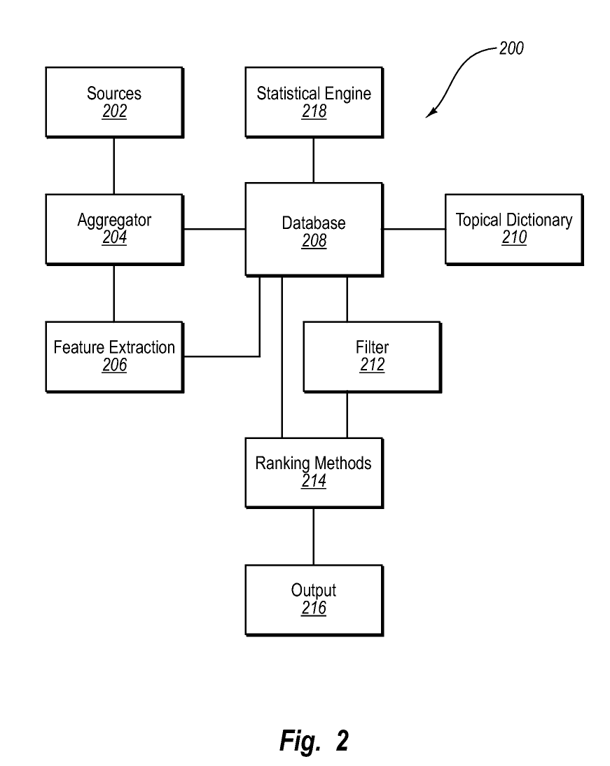

FIG. 2 illustrates one embodiment of a system for discovering topics from sources of content. In this example, the system 200 performs semantic discovery and includes an aggregator 204, feature extraction 206, a statistical engine 218, a database 208, a collaborative filter 212, ranking methods 214, and an output 216. The output 216 is typically provided to a client. The connections between the various modules is exemplary in nature. One of skill in the art can appreciate, that other connections between the various modules may present directly or indirectly.

The aggregator 204 uses a network protocol such as HTTP to download content from a variety of sources 202. The sources 202 may include, by way of example and not limitation, RSS-type feeds, e-mail newsletters, internet websites, e-mails, newsgroups, videos, multimedia content, and/or audio transcripts or any combination thereof

In one embodiment, the content of each of the sources 202 can contain one or more documents, which may be updated from time to time. Documents from the sources 202 can be composed of one or more articles. In other words, the content from the sources 202 can be hierarchical in nature, nested, or include related content, links, and the like.

The database 208 may be any persistent data storage mechanism such as a computer file system and/or relational database management system. The database 208 keeps record of all content (such as documents and articles) downloaded by the aggregator 204, including its related metadata. Metadata may include creation date, author, title, source, hyperlinks, etc. In one embodiment, the documents and articles are stored in text format within database 208.

One function of feature extraction 206 is to discover phrases within a document and/or related metadata. This can be done, for example, by parsing the document and/or related metadata. A phrase typically includes one or more words and a word typically includes one or more alphanumeric characters. The feature extraction 206 may use a stop word table, punctuation, and formatting hints to identify the end of a phrase. For instance, in the phrase, “Apple Computer announces 6 GB iPod Mini!”, the word “announces” and the exclamation mark indicate stop points for a phrase. By way of example only and not limitation, the phrases identified by the feature extraction 206 may include: “Apple”, “Apple Computer”, “Computer”, “6 GB”, “6 GB iPod”, “6 GB iPod Mini”, “iPod”, “iPod Mini”, “Mini”. In some instances, every possible combination of phrases may be extracted from the content. Further, there may be some instances where a phrase is inferred. For example, GB may be interpreted as gigabyte or vice versa. Words in the extracted phrases can be expanded or abbreviated. Embodiments of the invention, for example, may perform this type of action (expanding or abbreviating words) such that the resulting phrases are more consistent. The feature extraction 206 may also choose to ignore capitalization. In effect, the feature extraction 206 functions to identify phrases from content. In one embodiment, the phrases can be formulated for consistency. As discussed below, some of the consistency is also achieved by removing duplicate phrases.

The feature extraction 206 passes phrases into a statistical engine 218, which keeps count of each occurrence of a specific phrase. The count of each occurrence of a specific phrase may also related to time. As a result, a specific phrase can be associated with multiple time units such as within the last hour, within the last two days, between two to three weeks ago, and the like or any combination thereof The ability to generate phrases that are time dependent enables embodiments of the invention to identify content that is also time dependent. This is one example of how a phrase cloud is generated that includes or refers to content that is time dependent. This enables, for example, the generation of a phrase cloud that refers to content of a certain age or enables the semantic engine to compare scores of phrases over various time periods. The statistical engine 218 may include a computer memory data structure such as a hash table to store the phrases and/or the associated counts and time dependency.

The statistical engine 218 can output a ranked list of phrases using various scoring or ranking methods 214. Scoring or ranking parameters may include: phrase frequency, source popularity rank, manual editorial rank, collaborative filter rank, user-specific profile information, user actions or other user behavioral data related to the phrases (clicks on a phrase, times that specific content is viewed, page accesses, time content is read, selection of a particular document from a ranked list of documents, etc.), and parameter changes thereof Examples of ranking methods 214 may include, new phrases within a given time window, phrases with the highest historical frequency, phrases with greatest frequency change over a given time window. For retrieval efficiency, the statistical engine 218 and the ranking methods 214 may pre-compute and store their output into the database 208.

The output 216 can be presented on a graphical user interface, which may be related to a client and server computer pair. The client generally includes a network-enabled web browser or mobile WAP browser. The server outputs content and formatting information (i.e., XHTML) based on the client's request. The client's web browser renders the content and formatting for the user. Client and server may reside on a single computer system and client is not restricted to a web browser.

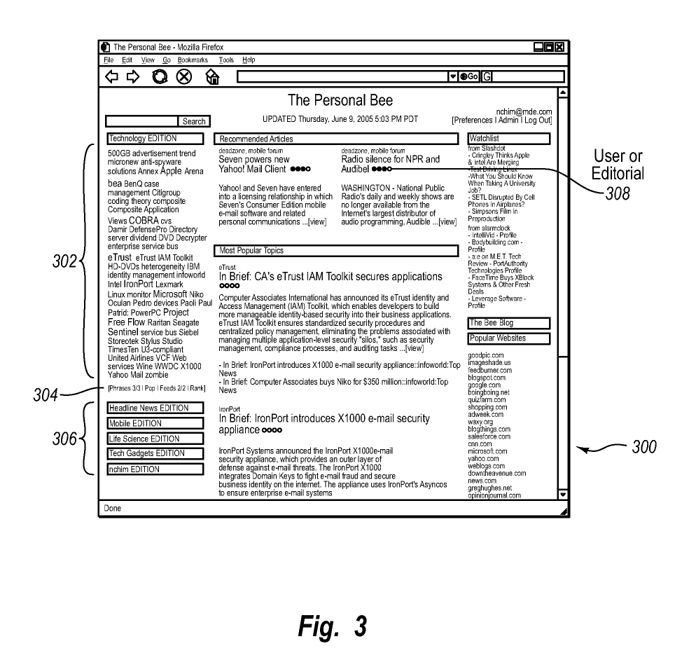

In one embodiment, the user is presented with a ranked phrase cloud as shown in FIG. 3, which also illustrates other features of an exemplary page displayed on a user interface. A phrase cloud is a visual representation of the highest ranked phrases as determined by the ranking methods, although any of the phrases can be displayed for other reasons. Further, the length of the phrase cloud or number of references can be set by a user or by default. The phrases can be presented in the phrase could in various ways that enable a user to quickly comprehend their relative ranking. The font size, for example, of the various phrases in the phrase can be set to its statistical rank score. Phrases may also be rendered in alternating colors, which enables distinct phrases to be quickly identified. When the user mouse clicks on a phrase or otherwise selects a particular phrase, the server returns documents/articles relevant to the selected phrase in ranked order. As a result, a particular phrase may be associated with multiple documents that are related to the selected phrase.

The web page 300 in FIG. 3 illustrates a phrase could 302 that has been generated by a remote server. The phrases in the phrase cloud 302, when clicked or selected, return one or more documents that are typically ranked. The ranking 304 enables a user to display phrases in different ways. For example, phrases can be presented alphabetically, by popularity, by ranking, by source, and the like or any combination thereof.

A user can also select specific editions 306. When a particular edition is selected, the phrase cloud 302 may change to represent the phrases that are associated with the selected edition. A user or editorial indicator 308 may also be presented on the page 300. Alternatively, the editorial aspect may be an integral part of the phrase cloud 302 as previously described.

Multiple clients can interact with server. The server may record the frequency of phrase and document/article requests and can augment the ranking methods with this information. For instance, if the fifth ranked phrase is accessed ten times more frequently than the first ranked phrase, the ranking method 214 may boost the rank of the fifth ranked phrase. Alternately, an authorized user may subjectively change the rank of phrases, articles, or sources for the benefit of other users. In this scenario, the authorized user serves the function of a traditional editor, whose efforts improve the consumption efficiency for her peers.

The system 200 can allow for greater readership participation beyond passively tracking click-popularity. For each article/document, users can supplement the keyphrase extraction results with manually defined tags. For instance, a user can tag the aforementioned article about the iPod Mini with the following tags: “Apple iPod Mini” and “MP3 Player”. This collective tagging process helps the system 200 draw additional relationships between articles/documents.

Alternatively, users' third-party client software can access the system 200 via an export API instead of the default web browser client. An export API can return either a machine-readable XML file or a block of XHTML code, which includes metadata, content and formatting. For example, the GetPhraseCloud command can allow a third-party client software to request and render the phrase cloud independent of the default client. All further interactions with system 200, such as article retrieval, can be facilitated via an export API.

The database 208 can be partitioned into multiple editions, or topic areas. Each edition can contain either its own sources or shared sources. One characteristic of an edition is that it maintains its own phrase statistics. The phrase statistics can be stored, for example, in a topical dictionary 210. Alternatively or in addition, the topical dictionary 210 may include phrases that are specific to a particular topic. As a result, the topical dictionary 210 allows each edition to be tuned separately from each other and resolves ambiguous phrase definitions between topics. An edition can have one or more authorized user or editor who can exercise editorial oversight for an edition. Editions can be either flagged as private or public. An authorized user can grant access to private editions to any authenticated user.

Another advantage of a topical dictionary is the ability to characterize a source. A topical dictionary thus stores phrases that are typical with a given topic. By analyzing how a specific source of content compares with a topical dictionary, the source can be characterized as pertaining to a particular topic. This is advantageous, for example, for users that use editions that are for particular topics. The system 200 can include sources in a particular edition automatically using the topical dictionary 210.

A search edition is a special edition that uses a seed phrase in addition to zero or many sources to filter documents/articles. For example, an editor selects a phrase such as “IBM”. The aggregator 204 selects all documents/articles in the archive with the matching phrase. The feature extraction 206 and statistical engine 218 run unmodified from a standard edition. The net result is a phrase cloud containing all the phrases surrounding the seed phrase within the preset time window.

The present invention is especially useful for sorting through news-related sources and articles. However, it should be noted that this invention can also be applied to other domains. For instance, an edition can download real-time closed-caption data and metadata from radio and TV broadcasts to provide of an ongoing phrase could of topics “mentioned on the air.” In another embodiment, this invention can be used to create a visual map of a user's e-mail inbox, ranking the popularity of topics mentioned in a group of e-mails. The semantic discovery engines of the invention can be language independent. If desired, a translator can be integrated into the aggregator 204 to incorporate disparate-language sources 202.

The semantic discovery engine has illustrated its effectiveness in extracting topics of interest from a collection of RSS feeds. One embodiment of the invention has tracked 200-300 RSS feeds collecting over 300,000 articles/documents. The quality of the results has been steadily improving due to the maturation of the statistical engine. Overall, the results generated by the system have shown that the users can easily stay up-to-date on the latest trends for a particular industry. If the user misses a topic for whatever reason, the system's keyword search interface can be used to search the entire catalog of articles/documents. In other words, embodiments of the invention also enable a user to search one or more editions.

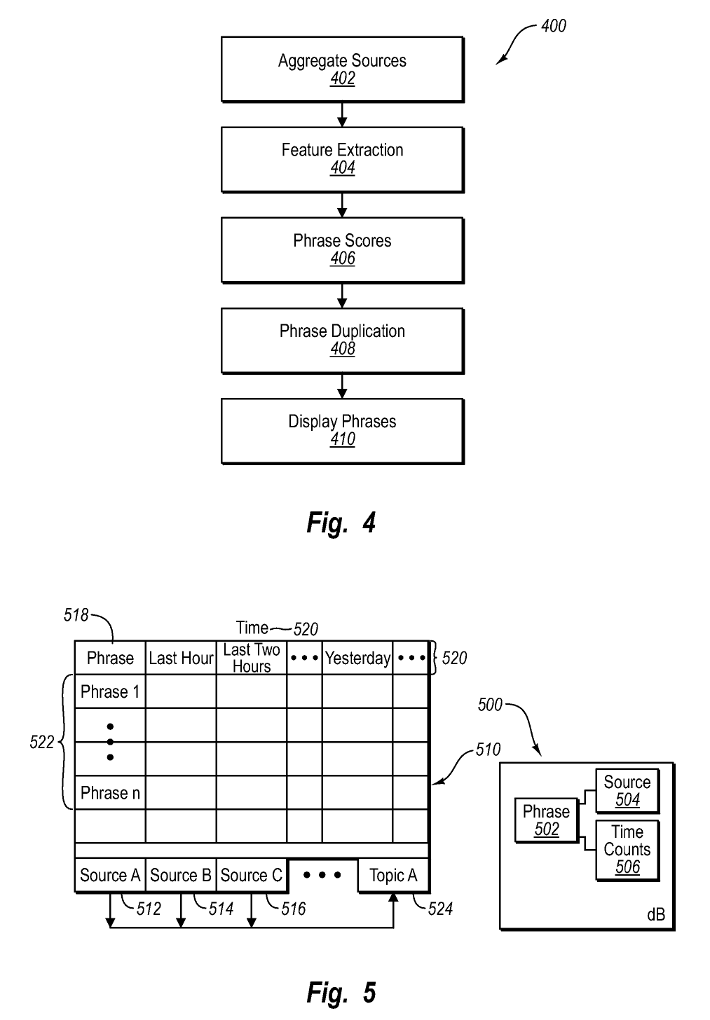

FIG. 4 illustrates an exemplary method for discovering topics of interest. As discussed herein, discovering topics of interest may include generating the phrase cloud for a general edition or for topical editions and the like or may include the generation of phrase scores that can be used in various ways as described herein. This embodiment of the invention begins by aggregating 402 one or more sources of content. Aggregating 402 content can include downloading content including metadata and storing the content and associated metadata in a database. The aggregation of content is typically a continual process as new content is continually being generated. As a result, embodiments of the invention are ongoing and changing. One result is that the phrase cloud is dynamic and time relevant. This is in contrast to conventional tags, which are static and not time relevant like the phrases in the phrase cloud.

After content is aggregated, feature extraction 404 is performed. Feature extraction can include identifying phrases in each document or article downloaded or identified by the aggregator. Identifying phrases may include looking at all possible sets of words that could be a phrase. As previously indicated, feature extraction includes measures that are intended to help identify phrases. A stop word dictionary, a language dictionary, and/or a topical dictionary can all be used during feature extraction. In one embodiment, a hash table of the phrases in a document or in multiple documents can be constructed.

Next, the phrases are scored 406. The generation of phrase scores can have multiple inputs. Some of the inputs reflect a time dependency that enables the ultimate phrase cloud to reflect documents that are also time relevant. A phrase score, for example, may use inputs that may include, but are not limited to: an time period of interest; a start time; a comparison between a time window of interest with prior time periods; frequency within a time window; historical frequency; the source of the content; editorial discretion; user actions; and the like or any combination thereof

After the phrases are scored, phrase de-duplication 408 is performed. One goal of phrase de-duplication is to remove redundant phrases. In one embodiment, this may simply be removing phrases that are encompassed within other phrases. For example, the phrase “mini iPod” may be removed because of the phrase “6 G mini ipod”. In another embodiment, however, phrase de-duplication is performed based on other factors. For example, considerations such as what documents are returned by each phrase, phrase score, and the like are also considered before removing duplicate phrases. For example, the phrase “mini iPod” and “Apple 6G” may return substantially similar results or have similar phrase scores. As a result, one of the phrases can be removed as being a duplicate of the other.

Next, the phrases are displayed 410. As previously described, the presentation of the phrase cloud to a user may use various features such that the ranking or other aspect of the phrases can be visually determined. Color can be used to separate one phrase from another. Font size can be used to reflect ranking. One of skill in the art, with the benefit of the present disclosure, can appreciate the use of other visual cues to reflect information about the phrases.

The phrase cloud displayed to an end user has several benefits. The phrase cloud is based on extracted content. As discussed previously, the phrases are generated from the content itself in some embodiments. Thus, the phrases reflect actual extracted content in some embodiments.

Also, the phrases are dynamically generated elements that can change over time for various reasons. In other words, the phrases in the phrase cloud are dynamic and/or time relevant. For example, new phrases in new content often end up in the phrase cloud because one of the inputs to the phrase score is the freshness of the content. As a result, the phrases change to reflect new content from the various sources. In another example, the time window used to assign phrase clouds often changes or shifts over time. If the time window is the last three days, for instance, then the phrases over the last three days changes each day and this change is reflected in the phrase cloud.

FIG. 5 illustrates one representation of the phrases that are stored in a database. The table 510 represents the data in the database 500. In this case, the database 500 stores phrases 502. The phrases are typically associated with a source 504 and with time counts 506. This information can be used, as described above, as inputs to generate, among other things, phrase scores. This information can also be used to generate topics.

The table 510 illustrates the relationships between phrases, time counts, and topics. In this example, the table 510 illustrates the phrases 522 and associated time counts 520. For example, phrase 1 may have counts in the last hour, the last two hours, yesterday, etc. The source B 514 and the Source C 516 can be similarly illustrated. The information in the table 510 also ages over time and the phrase scores can reflect this aging. In other words, phrases that are new today soon become old phrases that are weeks old.

By keeping this type of information, however, a historical frequency can be developed. For example, the frequency of a phrase over the last two days can be compared with the frequency over time or over any time period.

The table 510 also illustrates a topic 524 that is generated from the sources 512, 514, and 516. A topic can thus be constructed to include the phrases from multiple sources. After the table is constructed, time relevant phrase scores can be generated. In some instances, the time relevant phrase scores can be generated for specific topics. One of skill in the art can appreciate that the table 510 is representative of the relationships that may exist in a relational database.

### II Related Optimizations and Features for Enhancing Usability

Fundamental features of the semantic discovery engines of the invention and details regarding the operation thereof have been described above in reference to FIGS. 1 through 5. The following discussion expands of some of the features described above and provides further disclosure relating to various enhancements, optimizations, and related concepts. Embodiments of the invention can be practiced with or without any or all of the following features.

A. Settling Time for Editions

The statistical engine may require a substantial number of documents or articles (5,000+) in order to establish a meaningful statistical baseline. The task of the statistical engine is to filter up keyphrases that are unique or rare when compared to a statistical baseline for a given edition. At the creation of an edition, the statistical engine may not be able to discern the relative importance of a phrase such as “earnings report” versus a rare phrase such as “SD400”. However, over time, the statistical engine determines that “earnings report” is a relatively generic and frequently used phrase while “SD400” is new and possibly interesting. The statistical engine may rank new and rare phrases at the top of the list.

There is no requirement of 100% accuracy. It turns out that most new topics of interest contain more than one new keyphrase (3-4 phrases is more the norm). So if for some reason, the statistical engine omits a relevant keyphrase from the ranked list of phrases in the phrase cloud, the remaining 2-3 phrases will still show up in the phrase cloud.

B. De-Duplication of Keyphrases

Oftentimes, keyphrases listed in the phrase cloud are synonymous. While algorithmically correct, the user can be presented with a lot of redundant information thus cluttering the user interface. A simple keyphrase de-duplication function is used to collapse related keyphrase together. For instance, the following phrases may appear in the phrase cloud separately: “iPod Mini”, “Apple iPod Mini”, “Apple iPod Mini 6 GB”. For the given time window of interest, these terms refer to the same product announcement. The de-duplication algorithm looks for common strings embedded within another string and roots out the shorter of the two strings. In this example, since the first two phrases are fully contained in the third phrase, the first two phrases are systematically suppressed. However there are situations where this simplistic algorithm can by augmented by other processes, such as when an ambiguous word is shared among two phrases. To limit the extent of the de-duplication algorithm, the phrase matching process may only conducted on statistically adjacent keyphrases. As previously described, de-duplication may also take into account the specific documents returned by each phrase, and/or the phrase scores.

C. De-Duplication of Articles

For instances where multiple popular keyphrases point to the same article, the System can detect duplication by its unique “ArticleID” and present only a single copy of the article. This ensures that the articles returned to a user are usually distinct in many instances.

D. Dictionary Maintenance

The system includes a global dictionary and an edition-specific dictionary (a topical dictionary). Since editions represent different topic domains, a phrase that is interesting in one domain may be considered too generic for another domain. The edition-specific dictionary allows an authorized user to add edition-specific phrases into the dictionary. Furthermore, an authorized user can set a lifespan for a given phrase in the edition-specific dictionary.

There are two primary types of phrases in the dictionaries: stop words and weak words. Stop words cause the feature extraction to end a phrase. Examples of stop words include prepositions, adverbs and most verbs. Weak words are words and phrases that are ambiguous in and of themselves. For instance, the term “earnings release” is not specific enough to denote an interesting topic. Therefore, it should be added to the weak word database and suppressed from the phrase cloud. In one embodiment of the semantic discovery engine, entries can by manually appended into the dictionaries and the dictionaries have been adapted to ensure that entries are not too aggressive as certain words/phrases are used in many parts of speech and very common words can be part of proper names.

E. Clustering Similar Articles/Documents

After experimentation, it has been discovered that, by using the feature extraction module to append statistically interesting keyphrase to each article/document's metadata, documents can be clustered around a keyphrase by using the database's native inverted search index feature. This method is considered a form of “auto-keyphrase tagging.” This automatic tagging method can be used with manually tagging disclosed above to further improve clustering effectiveness. Moreover, this clustering method is less complex than other techniques that might be used, such as latent semantic indexing or document classification to group like documents together.

F. URL Extraction

The Statistical Engine can rank URL domain names separately from keyphrases to identify new and interesting websites that can be explored by users.

G. Index Follow Links

Many articles in RSS-type feeds contain only a short sentence or digest of the actual document of interest. An extension of the System is to follow each article's hyperlink to download and index the full article. Processing and storing a copy of the full article can provide more input into the statistical engine and can equalize the statistical effect of a short RSS article compared to its full-text counterpart.

H. Image Extraction

Many RSS articles contain an image related to the article topic. By extracting the image link, the System can consistently place and resize an image to normalize the user interface. In addition, images can be to augment the phrase map thus further enhancing usability.

### III. Exemplary Operating Infrastructure

Embodiments of the present invention include or are incorporated in computer-readable media having computer-executable instructions or data structures stored thereon. Examples of computer-readable media include RAM, ROM, EEPROM, CD-ROM, or other optical disk storage, magnetic disk storage or other magnetic storage devices, or any other medium capable of storing instructions of data structures and capable of being accessed by general purpose or special purpose computers, personal digital assistants, mobile telephones, and other devices with data processing capabilities. Computer-readable media also encompasses combinations of the foregoing structures. Computer-executable instructions comprise, for example, instructions and data that cause general purpose computers, special purpose computers, or other processing devices, such as personal digital assistants or mobile telephones, to execute a certain function or group of functions. The computer-executable instructions and associated data structures represent an example of program code means for executing the steps of the invention disclosed herein.

The invention further extends to computer systems adapted to be used with the Semantic Discovery Engines described herein. Those skilled in the art will understand that the invention may be practiced in computing environments with many types of computer system configurations, including personal computers, multi-processor systems, network PCs, minicomputers, mainframe computers, personal digital assistants, mobile telephones, and the like. The invention has been described herein in reference to a distributed computing environment, such as the Internet, where tasks are performed by remote processing devices that are linked through a communications network. In the distributed computing environment, computer-executable instructions and program modules for performing the features of the invention may be located in both local and remote memory storage devices.

The present invention may be embodied in other specific forms without departing from its spirit or essential characteristics. The described embodiments are to be considered in all respects only as illustrative and not restrictive. Moreover, the scope of the invention disclosed in detail herein will be defined by claims to be included in any non-provisional applications that will be filed during the pendency of this provisional application.

We claim:

1. A method for discovering topics of content from one or more sources of the content, the method comprising:
aggregating content from one or more sources;
extracting phrases from the content; and
determining a phrase score for each phrase extracted from the content.

2. The method of claim 1, further comprising providing a phrase cloud to a user, the phrase cloud including one or more phrases that are selected based on at least the phrase scores, wherein the one or more phrases are associated with specific documents included in the content from the one or more sources.

3. The method of claim 1, wherein aggregating content from one or more sources further comprises one or more of:
downloading documents from the one or more sources and storing the documents in a database; and
storing metadata of the documents in the database.

4. The method of claim 1, wherein aggregating content from one or more sources further comprises aggregating content from one or more of RSS feeds, websites, e-mail newsletters, e-mails, newsgroups, videos, multimedia content, or audio transcripts.

5. The method of claim 1, wherein extracting phrases from the content further comprises one or more of:
inferring phrases or portions of phrases for at least one document;
identifying one or more phrases for each document; or
identifying the phrases using stop words, weak words, prepositions, adverbs, punctuation or dictionaries.

6. The method of claim 1, wherein extracting phrases from the content further comprises associated a time window for each phrase and counting occurrences of each phrase in the content.

7. The method of claim 1, wherein determining a phrase score for each phrase extracted from the content further comprises identifying a time window for each phrase.

8. The method of claim 7, wherein determining a phrase score for each phrase extracted from the content further comprises one or more of:
comparing the time window with a prior time window;
identifying a frequency in the time window for each phrase;
identifying a historical frequency for each phrase;
accounting for a source of each phrase;
receiving editorial discretion from an authorized user; or
user behavioral data.

9. The method of claim 8, wherein the user behavioral data includes at least one of clicks on a particular phrase, articles viewed, or pages that are accessed by the user.

10. The method of claim 1, further comprising removing duplicate phrases.

11. The method of claim 10 wherein removing duplicate phrases further comprises one or more of;
removing phrases that are completely contained in other phrases;
considering documents returned for each phrase; or
considering phrase scores for each phrase.

12. The method of claim 1, wherein providing a phrase cloud to a user further comprises displaying the phrase cloud with visual cues, the visual clues enabling a user to select a specific phrase.

13. The method of claim 12, wherein the visual cues include one or more of phrase color and font size, the font size in proportion to a ranking of each phrase in the phrase cloud.

14. The method of claim 1, wherein only phrases with a high ranking are included in the phrase cloud.

15. The method of claim 1, wherein the phrase cloud is generated for a particular topic or edition.

16. The method of claim 1, further comprising presenting a ranked list of documents based on selection of a specific phrase in the phrase cloud by a user.

17. The method of claim 16, further comprising presenting a particular document to the user that is selected from the ranked list of documents.

18. In a system that includes one or more clients having access to a network, a semantic engine for discovering topics of interest from content provided by multiple sources, the semantic engine comprising:
an aggregator that receives content from one or more sources and stores the content and metadata of the content in a database;
a feature extraction module that identifies phrases from the content and metadata stored in the database;
a statistical engine that counts occurrences of each phrase in the content, wherein the occurrences are also associated with one or more time windows; and
a ranking method module that generates phrase scores for the phrases stored in the database, wherein the ranking method module uses the one or more time windows associated with each phrase to generate the phrase scores of the phrases.

19. The semantic engine of claim 18, further comprising a presentation module that generates a phrase cloud for display to an end user, the phrase cloud including a set of phrases having the highest phrase scores.

20. The semantic engine of claim 18, further comprising a module that eliminates duplicate phrases based on one or more of:
determining whether a phrase is subsumed in another phrase;
comparing documents returned by one or more phrases; and
comparing phrase scores.

21. The semantic engine of claim 18, further comprising one or more topical dictionaries, wherein each topical dictionary can determine relevancy of a particular phrase for a particular topic.

22. The semantic engine of claim 18, wherein the ranking method module generates the phrase scores based on one or more of a time window of interest, a start time, a frequency in the time window of interest, a historical frequency, a source of the content, user behavioral data, or editorial discretion.

23. The semantic engine of claim 18, wherein the phrase could is at least one of based on extracted content, dynamically generated, and time relevant.

24. The semantic engine of claim 18, wherein the phrase cloud includes visual cues including font size to indicate ranking and color to distinguish one phrase from the next.

25. The semantic engine of claim 18, wherein the occurrences of a phrase are used for topic categorization.

26. A method for discovering content from one or more sources of the content, the method comprising:
aggregating content from one or more sources at a database, including metadata for the content;
extracting phrases from the content and from the metadata, wherein the extracted phrases are associated with one or more time periods; and
determining a phrase score for each phrase extracted from the content, wherein the phrase score for each phrase has a time dependency.
